(19) United States
(12) Patent Application Publication
(10) Pub. No.: US 2008/0041416 A1
(43) Pub. Date: Feb. 21, 2008

(54) Dispensing brush

(76) Inventors: James Mathews, Sachse, TX (US); Richard Mathews, Sachse, TX (US)

Correspondence Address: M2 Ventures LLP, 6707 Bradford Estates Drive, Sachse, TX, 75048, US

(21) Appl. No.: 11/388,254

(22) Filed: Mar. 23, 2006

Related U.S. Application Data
(60) Provisional application No. 60/672,004, filed on Apr. 15, 2005.

(51) Int. Cl. B08B 1/00; A46B 5/00; B08B 3/04; B25G 1/00

(52) U.S. Cl. 134/6; 15/104.94; 15/143.1; 15/159.1

(57) ABSTRACT

A dispensing brush is used to groom while deodorizing and/or styling the receiver. The receiver can be a human but is commonly a household pet such as a dog or cat. The brush is comprised of a head attached to a handle and includes a bristle cap mounted to the head. Within the handle or the head, an internal cavity is provided that is in communication with an intake reservoir. A pump is also provided within the head or handle of the brush with the intake of the pump in communication with the intake reservoir and a pump output provided through a void in the bristle cap. The intake reservoir includes a depression or other structure such as a wall to create a pocket of fluid, which is held in reserve in the internal cavity, thereby making it accessible to the intake of the pump even when the brush is moved in a variety of positions. The intake reservoir may also include a check valve to further aide in restricting fluid from flowing back into internal cavity from the intake reservoir. The ability of the brush to be manipulated in space without the pump “sucking air” is valuable in that the disclosed brush is commonly used to dispense the enclosed liquid concurrently with the act of brushing.

### RELATED U.S. APPLICATION DATA

Provisional application No. 60/672,004 filed on Apr. 15, 2005.

### FIELD OF THE INVENTION

The present invention generally relates to grooming products. More specifically, the present invention relates to brushes used for humans and household pets.

### BACKGROUND OF THE INVENTION

Grooming is a part of everyday life for all of civilized societies. This includes not only humans, but also our pets. We as humans are constantly looking for more efficient and effective tools for living. Time saving tools are ever more useful in our ever more demanding world. A 10-minute session of brushing and styling our hair in the morning accounts to over two and a half 24-hour days a year in time spent. Any innovation that reduces that time requirement by 2-3 minutes per day results in over 18 hours of extra time per year.

In terms of pets, according to the American Veterinary Medical Association (AVMA) in 2001, 36.1% of all households in the United States had a dog as a household pet. In addition 31.6% of all households owned a cat. At an average of 2.67 people per household and 298 million people in the U.S., there would be over 40 million dogs and over 35 million cats as household pets in the U.S. If the owner takes a 90-minute trip to the groomer once a month for 50% of the dogs, the total U.S. time investment is 360 million man-hours per year. A product that could effectively reduce the once per month trip to once every other month would save the U.S. 180 million man-hours per year. Using an average minimum wage of $6.00/hour, this accounts for over $1 billion annually. This is time and money that can be spent in more productive ventures.

### SUMMARY OF THE INVENTION

In one aspect, the invention features a dispensing brush including a brush head and a brush handle together comprising a brush base. The brush base includes an internal cavity with an intake reservoir and a pump secured to the brush base. The pump includes an intake in communication with the intake reservoir and a nozzle adapted for pump output adjacent to the bristle cap, which is mounted to the brush base. The bristle cap includes bristles extending from the cap and also includes a void adjacent to the nozzle of the pump. In one aspect the internal cavity is provided in the handle and includes a cap enabling access to the internal cavity. The cap is preferably a replaceable cap, thereby enabling repeated access to the internal cavity. The intake reservoir preferably includes a depression, such as an arcuate deformation on a lower aspect of the internal cavity.

In another aspect of the invention, the intake reservoir may be partially defined by a section wall dividing the internal cavity and including an upper opening to allow fluid transfer into the intake reservoir. Another alternative is disclosed in which the intake reservoir is partially defined by a dividing wall in the internal cavity and further includes a check valve. The check valve may be comprised of a ball that is received by a drain port in the dividing wall, thereby inhibiting fluid flow from the intake reservoir to the internal cavity.

The invention may further include an aromatic fluid received in the internal cavity and dispensed by the pump through the void onto a receiver. The receiver is preferably a person or an animal, such as a household pet. The fluid can also include an odor neutralizing fluid such as the proprietary deodorizer ORDENONE™. The fluid may also be an aromatic fluid that may include one or more fragrances. The odor neutralizing fluid, fragrance(s), flea and tick control, other pest control, conditioners or dry shampoo may also be used in combination.

The device may further include a pump actuator moveably mounted to the brush base and including a button accessible to a user. In this manner, the pump actuator enables actuation of the pump. The pump actuator may include a pump arm providing contact with the pump and a button accessible to a user, whereby movement of the button by the user actuates the pump. The pump is preferably comprised of a linear actuated pump sprayer. The void in the bristle cap may be an oval shaped slot in a surface of the bristle cap.

The invention also includes the method of grooming including the use of the elements of the invention as listed and including the steps of providing a fluid that is placed in the internal cavity, then positioning the bristles adjacent to a receiver and actuating the pump and dispensing the fluid onto the receiver. The method of grooming can also include the step of brushing the receiver as the fluid is being dispensed.

### BRIEF DESCRIPTION OF THE DRAWINGS

The foregoing and other objects of this invention, the various features thereof, as well as the invention itself, may be more fully understood from the following description, when read together with the accompanying drawings, described:

FIG. 1 is an isometric separated view of one form of a dispensing brush showing the internal components of a brush produced in accordance with the present invention.

FIG. 2 is an isometric separated view with the handle joined to the head of one form of a dispensing brush showing the internal components of a brush produced in accordance with the present invention.

FIG. 3 is an isometric separated view of one form of a dispensing brush shown from the bottom with the handle and head joined and a pump actuator positioned in the head, the components of a brush produced in accordance with the present invention.

FIG. 4 is an isometric partially separated bottom view of one form of a dispensing brush showing the bristle cap removed from the brush base, the brush produced in accordance with the present invention.

FIG. 5 is an isometric view of one form of a dispensing brush shown from the bottom, the brush produced in accordance with the present invention.

FIG. 6 is an isometric view of one form of a dispensing brush shown from the top, the brush produced in accordance with the present invention.

FIG. 7 is a top view of a dispensing brush produced in accordance with the present invention.

FIG. 8 is a sectioned view of a dispensing brush produced in accordance with the present invention.

FIG. 9 is a sectioned view along the same section line 8-8 further illustrating the function of the dispensing brush with a dispensing fluid, the brush produced in accordance with the present invention.

FIG. 10 is a sectioned view along the same section line 8-8 further illustrating the function of the dispensing brush when in a descending position, the brush produced in accordance with the present invention.

FIG. 11 is a sectioned view along the same section line 8-8 further illustrating the function of the dispensing brush when in an ascending position, the brush produced in accordance with the present invention.

FIG. 12 is a sectioned view along the same section line 8-8 further illustrating a variation in the intake reservoir including a dividing wall and a dispensing fluid, the brush produced in accordance with the present invention.

FIG. 13 is a sectioned view along the same section line 8-8 further illustrating a variation in the intake reservoir including a check valve and a dispensing fluid, the brush produced in accordance with the present invention.

FIG. 14 is a partial sectioned view along the same section line 8-8 of the handle and a portion of the head further illustrating the function of the check valve in the intake reservoir wherein the dispensing fluid is free to flow into the intake reservoir, the brush produced in accordance with the present invention.

FIG. 15 is a partial sectioned view along the same section line 8-8 of the handle and a portion of the head further illustrating the function of the check valve in which the fluid is blocked from exiting the intake reservoir, the brush produced in accordance with the present invention.

For the most part, and as will be apparent when referring to the figures, when an item is used unchanged in more than one figure, it is identified by the same alphanumeric reference indicator in all figures.

### DETAILED DESCRIPTION OF THE INVENTION

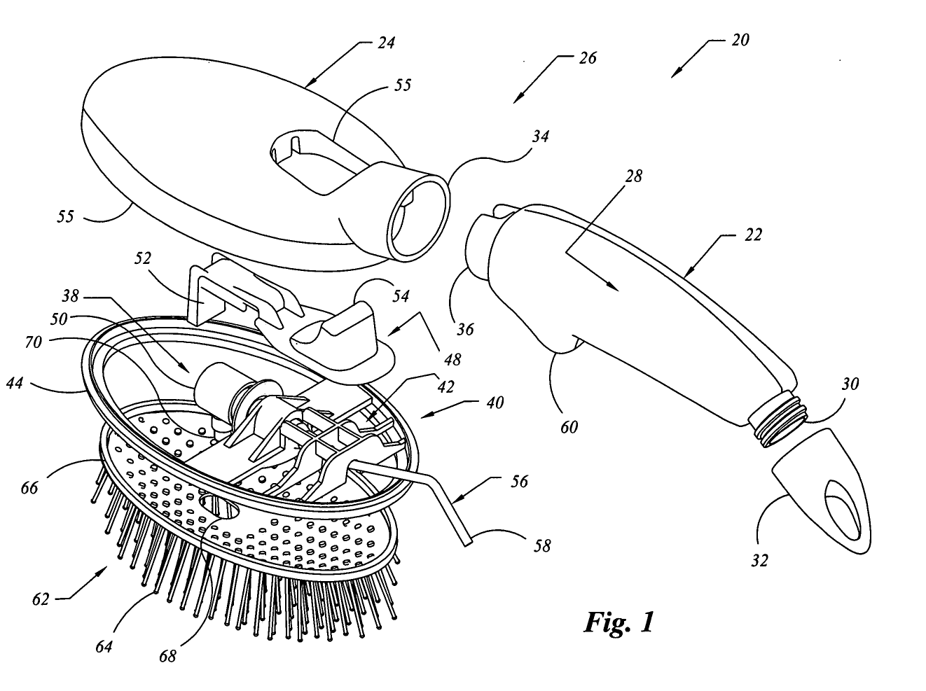

The present invention is a dispensing brush used for grooming and other hair or skin treatments of humans and pets. A typical example of the brush 20 in a separated or exploded view is illustrated in FIG. 1. The brush 20 includes a handle 22 and a brush head 24. Together these two components may be referred to as a brush base 26. In this form as shown, the handle 22 includes an internal cavity 28, in which access is granted through the opening 30. A cap 32 allows repeated access to the cavity 28 and allows the cavity 28 to be sealed when the cap 32 is in place on the end of the handle 22.

The handle 22 is received by the neck 34 of the brush head 24 and attached thereto to form a rigid base. These two parts can be secured together in a variety of methods. They can be fastened by mechanical means or by chemical adhesive. In the form as shown, an adhesive is used to secure the handle tip 36 in the neck 34 of the brush head 24. The combination provides a secure platform to enable brushing the hair or coat of a human or animal.

The pump assembly is shown here in more than one part. The pump 38 is received by the pump frame 40. The pump frame 40 is a portion of the brush head 24 that has been displaced to show the components of the assembly. In this form the pump frame 40 is a separate part that includes a support frame 42 to secure the pump 38 to the head 24 when the pump frame 40 is rigidly mounted to the head 24. In this embodiment the frame ring 44 is mounted to the head lip 46, capturing the pump 38 therein. Also captured is the pump actuator 48. The pump actuator 48 is an extension of the pump 38 in that in some orientations of the pump 38 within the brush base 26, the pump head 50 is not easily accessible to a user. As such, the pump arm 52 of the pump actuator 48 contacts the pump head 50 and the button 54 extends through the head 24 via the head access 55. The pump actuator is movably mounted to the brush base 26. In this way the pump actuator 48 allows the finger of a user to apply force to the button 54 of the pump actuator 48 and thereby actuates the pump 38.

The pump 38 also includes a pump intake 56 that extends from the body of the pump 38. In this embodiment the intake 56 has a distinctive downward bend 58. When fully assembled, this downward bend 58 conforms to the shape of a depression 60 in the internal cavity 28 of the handle 22. The intake 56 is inserted through the neck 34 of the head and then through an access hole (not shown in this view) in the end of the handle tip 36. The details of this configuration will become more apparent further in this specification. Finally, a bristle cap 62 holds a plurality of bristles 64 in place, extending away from the brush base 26. The cap base 66 is preferably a pliable and resilient material that allows some “give” to cushion the bristles 64 when they contact the skin of scalp of the user, and yet offer a reaction force sufficient to make the bristles 64 reasonably secure at the same time. A void 68 is provided in the bristle cap 62 that is positioned adjacent to the nozzle 70 of the pump. The void 68 is preferably substantially oval in shape so as to allow for the longitudinal displacement of the nozzle 70 as the pump is actuated.

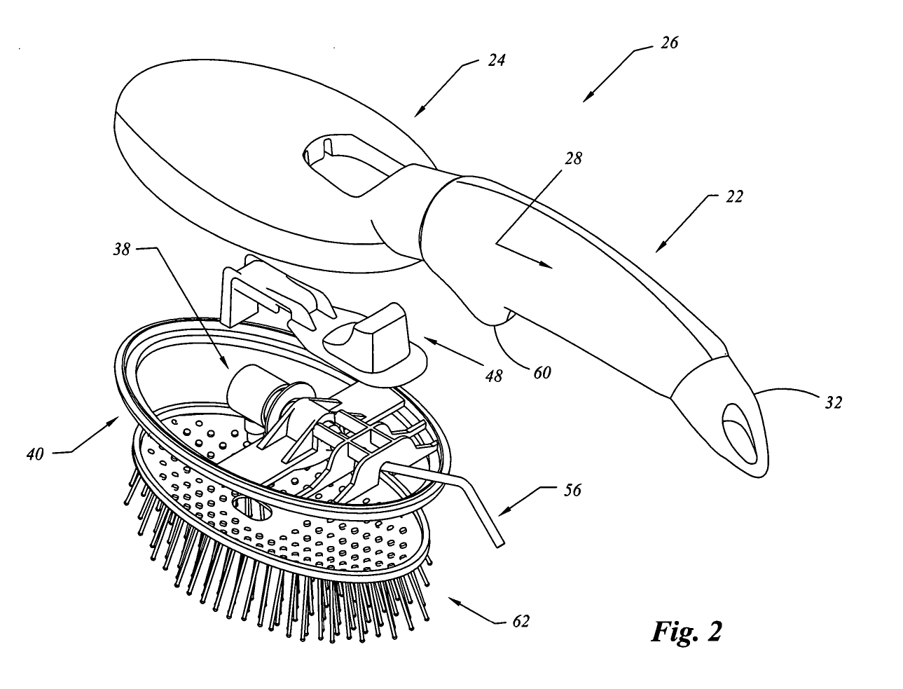

The handle 22 has been secured to the head 24 in FIG. 2. In addition, the cap 32 has been mounted to the distal end of the handle 22, thus sealing the internal cavity 28 of the handle 22 from the viewer's perspective. The remaining functional components of the brush, including the pump 38, pump frame 40 and bristle cap 62 are displaced to show a typical assembly process.

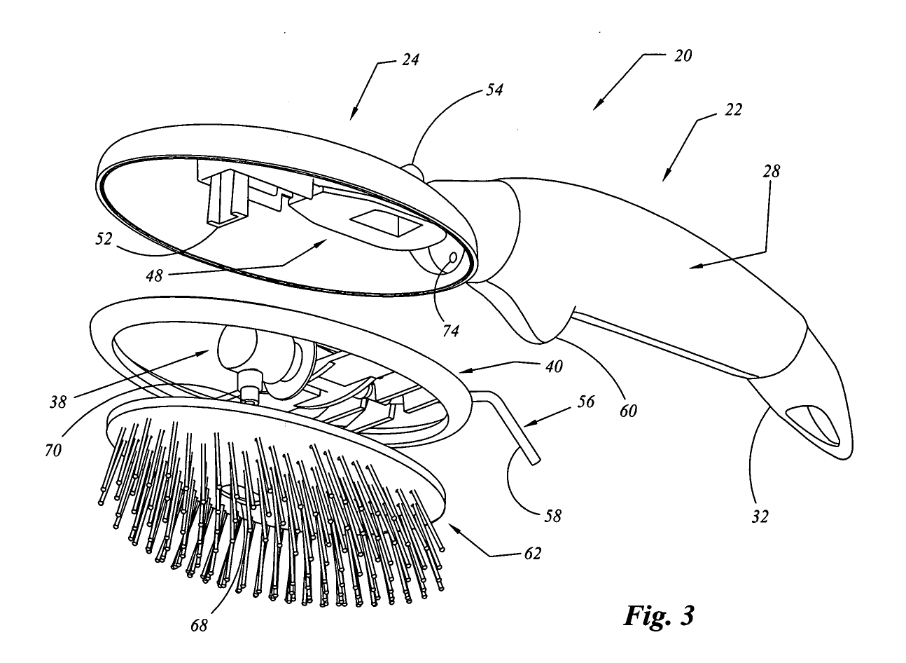

In FIG. 3, an isometric view showing the bottom side of the partially assembled brush is illustrated. The pump actuator 48 has been assembled into the head 24 of the brush 20. The distal tube end 72 of the intake 56 is received by the access hole 74 in the handle 22. Here it can more clearly seen how the downward bend 58 of the intake 56 conforms to the depression 60 in the cavity 28 of the handle 22. This is done to enable pick-up of any fluid in the internal cavity 28, thereby creating an intake reservoir within the internal cavity of the brush 20, in this case, located within the handle 22. The pump 38 pulls fluid from the intake reservoir and exits the fluid through the nozzle 70. This passes through the void 68 in the bristle cap 62, allowing the fluid to be sprayed onto a receiver.

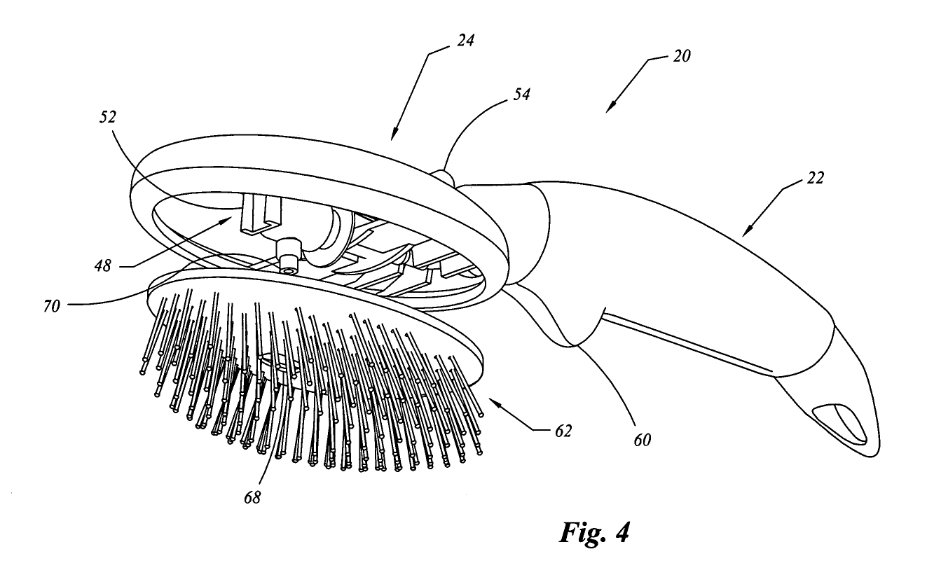

With the exception of the bristle cap 62, the brush 20 is fully assembled in FIG. 4. The button 54 of the pump actuator 48 is shown as assessable to a user with the pump arm 52 positioned adjacent to the pump 38 so as to actuate the pump when the button 54 is moved back toward the handle 22 of the brush 20. The nozzle 70 is shown over the void 68 in the bristle cap 62, thereby allowing flow of fluid as discharged from the nozzle 70.

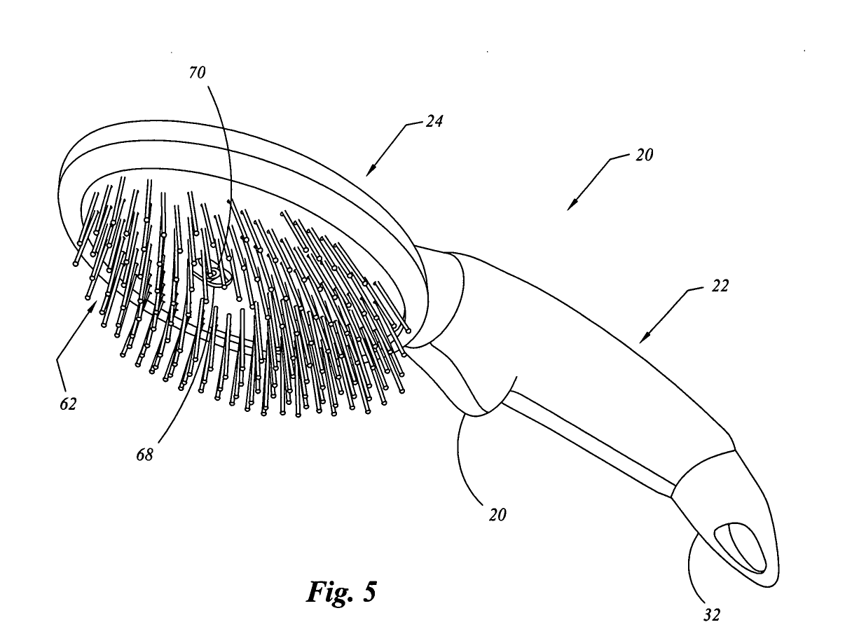

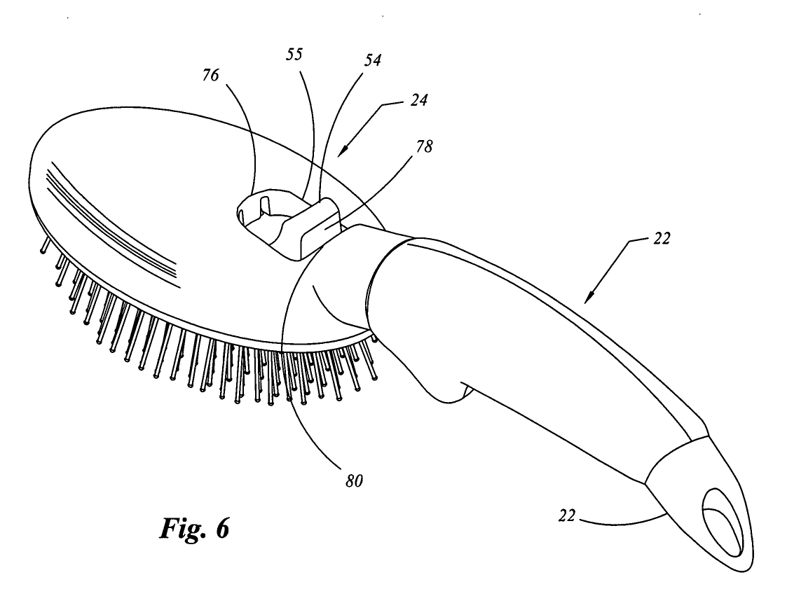

A fully assembled brush 20 is shown in FIG. 5. The handle 22 is mounted to the head 24 on one end and the cap 32 on the other end. The pump mechanism is housed within the brush 20 and in this view, hidden by the bristle cap 62. The nozzle 70 is visible through the void 68 as is necessary for material discharge through the nozzle 70 onto a receiver. The same assembled unit is shown from the top isometric view in FIG. 6. In this view the button 54 is clearly shown to extend through the top of the head 24. The space between the button 54 and the front edge 76 of the head access 55 is provided to give room for to position the user's finger. The distance between the button back 78 and the rear portion 80 of the head access 55 provides room for displacement of the button 54 within the head 24 to actuate the pump 38.

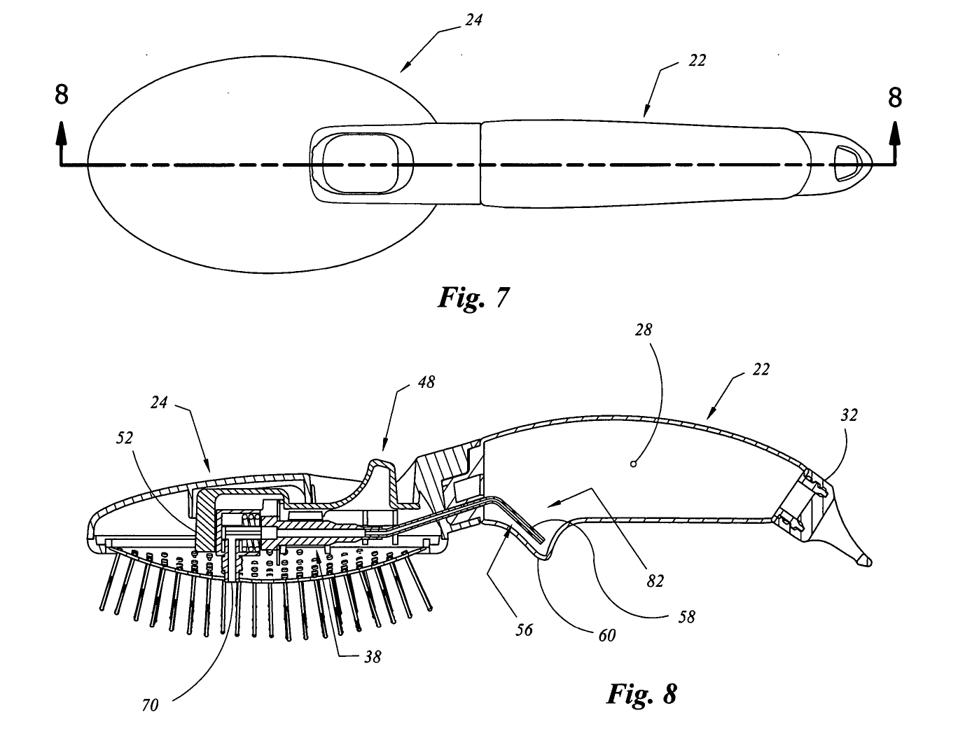

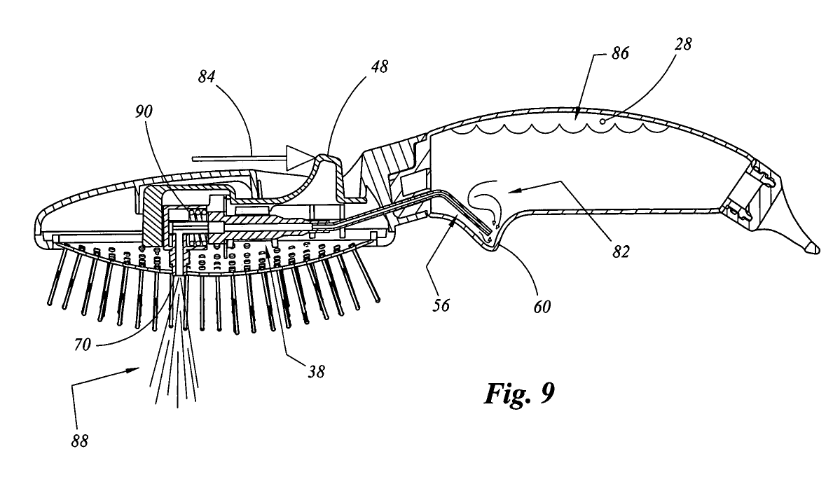

A more detailed view of this embodiment of the invention is shown in FIGS. 8-11 as based on the section line shown in FIG. 7. FIG. 8 further illustrates the internal cavity 28, here located in the handle 22. The depression 60 defines an intake reservoir 82 within the internal cavity 28. In all of the drawings shown in this disclosure the internal cavity 28 is provided in the handle 22, but this is not critical to the invention. The handle 22 provides a large storage area that would otherwise be wasted and therefore has been determined by the applicants to be the most advantageous location for the internal cavity 28. In a similar manner, the intake reservoir 82 needs to feed from the internal cavity 28 and optimally be refilled from movement of the handle. The cavity in the head 25 can form an intake reservoir, but it is more desirable to section the internal cavity 28 in one or more ways to create the refillable section. Either method would require the intake reservoir to receive the intake 56 from the pump 38. Another advantage to using the handle 22 for the internal cavity 28 is that the handle can be manufactured from a clear or semi-clear material such as PVC, polycarbonate, a variety of other clear plastics or glass. In doing so, the handle offers a visual display in that colored fluids 86 can be used in the brush 20. Also, the clear handle allows the user to see the fluid level in the brush 20 without removing the cap 32.

The pump 38 is actuated by movement of the button 48, as shown by the arrow 84. This movement drives the pump 38, providing the transfer of the fluid 86 from the intake reservoir 82, which is fed by the remainder of the internal cavity 28. The fluid 86 is pumped to output as a spray 88 through the nozzle 70. The pump 38 is recoiled by the spring 90, in this case housed within the body of the pump 38. The recoil drives the button 48 back (Opposite to the arrow 84) to this, the starting position.

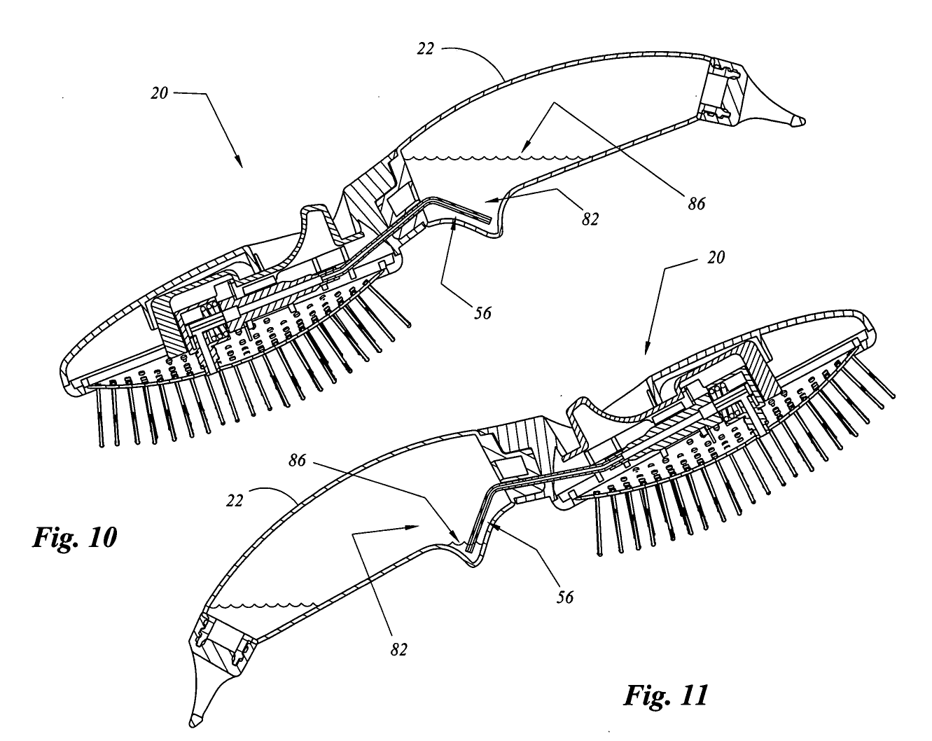

The value of the intake reservoir 82 is more fully illustrated in FIGS. 10 & 11. A brush, either for human use or for use on a pet, is very dynamic in that it is constantly in motion during use. Any spray bottle system will only work when the end of the intake 86 is under the fluid 86. As soon as the pump 38 is actuated and the end of the intake 56 sucks air, the pump 38 will fail to dispense fluid 86 and then need to be primed by pumping several times with the end of the intake 56 under the surface of the liquid 86. This is not only annoying to the user, in many cases the user will assume the internal cavity 28 is empty and discard the dispenser (in this case the brush 20) because the user finds it difficult to dispense the remaining fluid 86. With the intake reservoir 82, when the brush 20 is rotated forward, as in FIG. 10, the intake reservoir 82 is refilled. Then when the brush 20 is rotated back again, as in FIG. 11, a portion of the liquid 86 remains in the reservoir 82, thus allowing for several pumps of liquid 86 to be dispensed without “sucking air”.

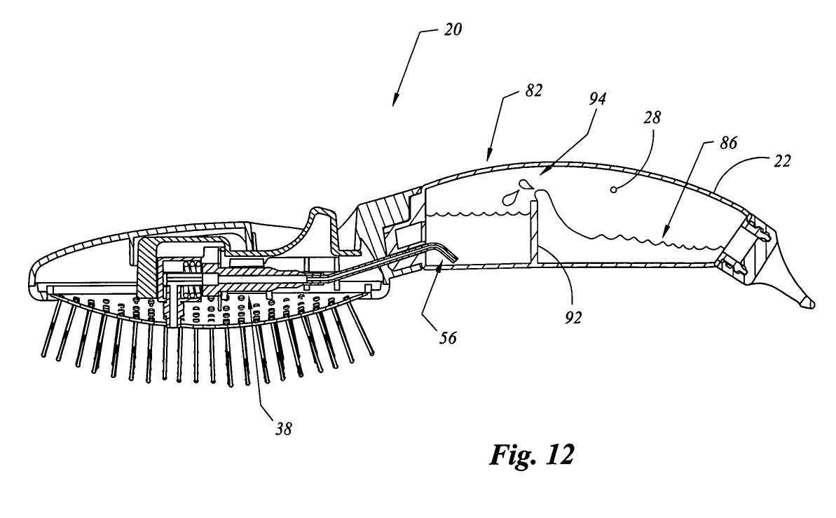

Another variation of the intake reservoir 82 is shown in FIG. 12. Here the depression has been removed from the bottom of the handle 22. The depression could still be used with this or any of the other embodiments of the intake reservoir 82, but is shown here without it to illustrate that the depression is not mandatory to the invention. In this embodiment, the intake reservoir 82 is comprised of a section wall 92 located within the internal cavity 28 of the brush 20. To the left of the section wall 92 is the intake reservoir 82. An upper opening 94 allows the fluid 86 to “slosh” over the wall 92 and be captured in the intake reservoir 82 during normal movement of the brush 20. In the bottom of the reservoir 82 is the intake 56 to the pump 38. This provides a captured volume of fluid 86 to minimize the likelihood of the pump 38 going dry and requiring to be primed during normal use.

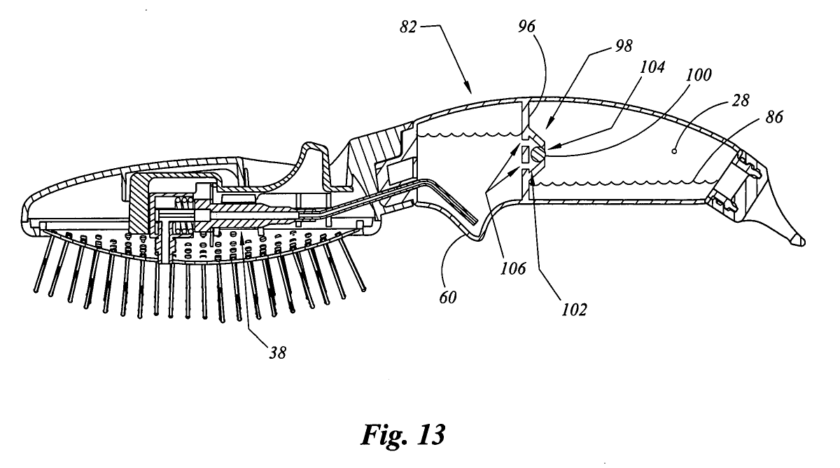

Another version of the intake reservoir 82 is shown in FIG. 13. Here a dividing wall 96 is located within the internal cavity 28, thus separating the internal cavity 28 from the intake reservoir 82. A check valve 98 is incorporated into the dividing wall 96 so as to allow fluid 86 to flow from the internal cavity 28 to the intake reservoir 82 but not to return back to the internal cavity 28. The check valve 98 can take a variety of forms. One embodiment is shown here including a ball 100 trapped in a ball cavity 102. The ball cavity 102 includes a drain port 104 that receives the ball 100 in a substantially sealed manner when fluid pressure is placed on it (as shown in this figure). On the opposite side of the ball cavity 102 there exists one or more access ports 106 to allow fluid 86 to drain into the intake reservoir 82 without being restricted by the ball 100. The depression 60 is also provided in this embodiment to further facilitate the removal of the fluid 86 from the intake reservoir 82 during use.

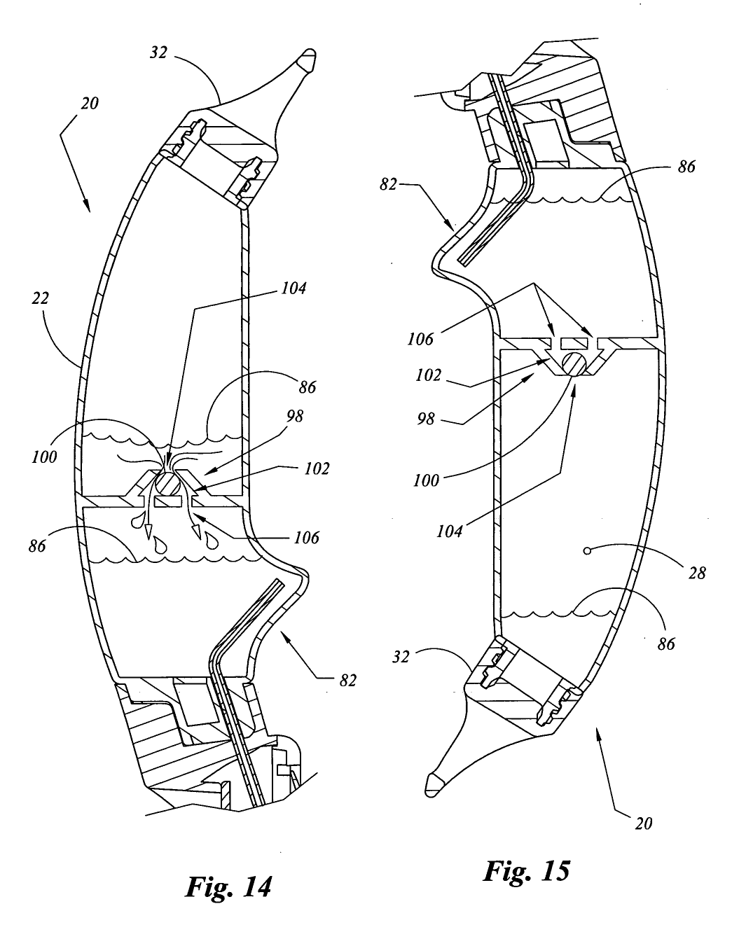

A more detailed view of how the check valve 98 works is shown in FIGS. 14 & 15. In FIG. 14 the brush 20 is inverted with the cap 32 above the head 24 (not shown). In this case the ball 100 falls to the back of the ball cavity 102, allowing the fluid 86 to flow through the access ports 106, into the intake reservoir 82. In FIG. 15 the brush 20 has been reversed with the cap 32 down and the brush head 24 (not shown) elevated. In this form the ball 100 is seated in the drain port 104 and held in place by the fluid pressure of the weight of the fluid 86, thus sealing the intake reservoir 82 and preventing the upper fluid 86 from exiting to the lower chamber of the internal cavity 28.

The fluid 86 can be of several types depending on what the user desires. For people, hair conditioning or styling products can be used. Detangling conditioners applied as the hair is brushed allows the user to apply the chemicals needed to assist in detangling the hair as a force of brushing is applied to facilitate the process. When hair is desired to increase in volume, hair spray can be added as the hair is “teased” up or simply brushed upward. The structural properties of the hairspray assist the hair in defying gravity. Hairspray is a type of adhesive that must be applied to the hair in the shape desired in that the hairspray dries quickly. By applying the hairspray as it is brushed, from the brush directly to the hair and not globally into the air around the hair, the process is enhanced.

In the area of pets, two critical things apply. Pet grooming has two elements, smoothing the coat and reducing odor. Pet hair attracts bacteria that live on the animal. The bacteria and their byproducts produce the offensive odor. Grooming by brushing and bathing remove the bacteria and their waste, thus reducing odor. The fluid in the disclosed invention can be an aromatic liquid that covers odors. This odor masking makes the odors less pronounced and thereby less offensive. Applying chemicals that bind to the odor causing molecules can also eliminate the odors. In addition, binding chemicals can be used in conjunction with perfumes.

Perfumes are available in a variety of forms and are useful for covering many odors. Products such as ORDENONE™ (Belle-Aire Fragrances, Inc., Mundelein, Ill., USA) claim to capture malodorous volatile mercaptan, sulfide, anine and other compounds without interfering with fragrance additives. The supplier claims this is accomplished chemically be the structure of their semi-rigid concave molecules that make up ORDENONE. This or other chemical deodorizers can also be used in the brush 20 as shown and described.

The invention as shown and described herein is the preferred embodiment of the invention as seen by the applicants. It is understood that an infinite number of variations of certain details are possible and therefore are inherently included in this disclosure.

What is claimed is:

1. A dispensing brush comprising:
a brush head and a brush handle together comprising a brush base including an internal cavity with an intake reservoir;
a pump secured to said brush base, said pump including an intake in communication with said intake reservoir and a nozzle adapted for pump output; and
a bristle cap mounted to said brush base, said bristle cap including bristles extending there from and a void adjacent to said nozzle of said pump.

2. The dispensing brush as in claim 1, wherein said internal cavity is provided in said handle.

3. The dispensing brush as in claim 2, wherein said handle includes a cap enabling access to said internal cavity.

4. The dispensing brush as in claim 3, wherein said cap is a replaceable cap, thereby enabling repeated access to said internal cavity.

5. The dispensing brush as in claim 1, wherein said intake reservoir is an arcuate deformation on a lower aspect of said internal cavity.

6. The dispensing brush as in claim 1, wherein said intake reservoir is partially defined by a section wall dividing said internal cavity and including an upper opening to allow fluid transfer to said intake reservoir.

7. The dispensing brush as in claim 1, wherein said intake reservoir is partially defined by a dividing wall in said internal cavity, said dividing wall including a check valve.

8. The dispensing brush as in claim 7, wherein said check valve is comprised of a ball that is received by a drain port in said dividing wall, inhibiting fluid flow from the intake reservoir to the remainder of said internal cavity.

9. The dispensing brush as in claim 1, further comprising an aromatic fluid received in said internal cavity and dispensed by said pump.

10. The dispensing brush as in claim 9, wherein said aromatic fluid includes at least one fragrance.

11. The dispensing brush as in claim 9, wherein said fluid is dispensed onto a receiver selected from the group consisting of a person and an animal.

12. The dispensing brush as in claim 10, wherein said animal is a household pet.

13. The dispensing brush as in claim 1, further comprising an odor neutralizing fluid received in said internal cavity and dispensed by said pump.

14. The dispensing brush as in claim 13, wherein said odor neutralizing fluid includes ORDENONE™.

15. The dispensing brush as in claim 13, wherein said fluid is dispensed onto a receiver selected from the group consisting of a person and an animal.

16. The dispensing brush as in claim 1, further comprising a pump actuator moveably mounted to said brush base and including a button accessible to a user, whereby the pump actuator enables actuation of said pump.

17. The dispensing brush as in claim 1, wherein said pump is comprised of a linear actuated pump sprayer.

18. The dispensing brush as in claim 1, wherein said void is an oval shaped slot in a surface of said bristle cap.

19. The dispensing brush as in claim 1, further comprising a pump actuator including a pump arm providing contact with said pump and a button accessible to a user, said actuator movably mounted to said brush base, whereby movement of said button by said user actuates said pump.

20. A dispensing brush comprising:
a handle providing an internal cavity with a intake reservoir, the cavity adapted for receiving a fluid;
a pump including a nozzle adapted for output, a pump body and a pump hose adapted for intake with an end received by said intake reservoir;
a head including a pump frame supporting said pump body; and
a bristle cap including a void adjacent to said nozzle, the bristle cap mounted to said head, whereby actuation of said pump displaces said fluid from said internal cavity through said void of said bristle cap onto a receiver.

21. The dispensing brush as in claim 20, wherein said handle includes a cap enabling access to said internal cavity.

22. The dispensing brush as in claim 21, wherein said cap is a replaceable cap, thereby enabling repeated access to said internal cavity.

23. The dispensing brush as in claim 20, wherein said intake reservoir is an arcuate deformation on a lower aspect of said internal cavity.

24. The dispensing brush as in claim 20, wherein said intake reservoir is partially defined by a section wall dividing said internal cavity and including an upper opening to allow fluid transfer to said intake reservoir.

25. The dispensing brush as in claim 20, wherein said intake reservoir is partially defined by a dividing wall in said internal cavity, said dividing wall including a check valve.

26. The dispensing brush as in claim 25, wherein said check valve is comprised of a ball that is received by a drain port in said dividing wall, inhibiting fluid flow from the intake reservoir to the remainder of said internal cavity.

27. The dispensing brush as in claim 20, wherein said fluid is comprised of an aromatic fluid.

28. The dispensing brush as in claim 27, wherein said aromatic fluid includes at least one fragrance.

29. The dispensing brush as in claim 20, wherein said receiver is selected from the group consisting of a person and an animal.

30. The dispensing brush as in claim 29, wherein said animal is a household pet.

31. The dispensing brush as in claim 20, wherein said fluid is comprised of an odor neutralizing fluid.

32. The dispensing brush as in claim 31, wherein said odor neutralizing fluid includes ORDENONE™.

33. The dispensing brush as in claim 20, further comprising a pump actuator including a pump arm providing contact with said pump and a button accessible to a user, said actuator movably mounted to said brush, whereby movement of said button by said user actuates said pump.

34. An improved brush of the type including a handle mounted to a head and a bristle cap with bristles extending from said bristle cap, the bristle cap mounted to said head, wherein the improvement comprises:
a substantially sealable internal cavity including a intake reservoir;
a pump mounted to said head including an intake in communication with said intake reservoir of said internal cavity and an output adjacent to said bristle cap; and
a void in said bristle cap, thereby enabling passage of a fluid from said pump through said void.

35. The dispensing brush as in claim 34, wherein said internal cavity is provided in said handle.

36. The dispensing brush as in claim 35, wherein said handle includes a cap enabling access to said internal cavity.

37. The dispensing brush as in claim 36, wherein said cap is a replaceable cap, thereby enabling repeated access to said internal cavity.

38. The dispensing brush as in claim 34, wherein said intake reservoir is an arcuate deformation on a lower aspect of said internal cavity.

39. The dispensing brush as in claim 34, wherein said intake reservoir is partially defined by a section wall dividing said internal cavity and including an upper opening to allow fluid transfer to said intake reservoir.

40. The dispensing brush as in claim 34, wherein said intake reservoir is partially defined by a dividing wall in said internal cavity, said dividing wall including a check valve.

41. The dispensing brush as in claim 40, wherein said check valve is comprised of a ball that is received by a drain port in said dividing wall, inhibiting fluid flow from the intake reservoir to the remainder of said internal cavity.

42. The dispensing brush as in claim 34, further comprising an aromatic fluid received in said internal cavity and dispensed by said pump.

43. The dispensing brush as in claim 42, wherein said aromatic fluid includes at least one fragrance.

44. The dispensing brush as in claim 42, wherein said fluid is dispensed onto a receiver selected from the group consisting of a person and an animal.

45. The dispensing brush as in claim 44, wherein said animal is a household pet.

46. The dispensing brush as in claim 34, further comprising an odor neutralizing fluid received in said internal cavity and dispensed by said pump.

47. The dispensing brush as in claim 46, wherein said odor neutralizing fluid includes ORDENONE™.

48. The dispensing brush as in claim 47, wherein said fluid is dispensed onto a receiver selected from the group consisting of a person and an animal.

49. The dispensing brush as in claim 34, further comprising a pump actuator moveably mounted to said brush base and including a button accessible to a user, whereby the pump actuator enables actuation of said pump.

50. The dispensing brush as in claim 34, wherein said pump is comprised of a linear actuated pump sprayer.

51. The dispensing brush as in claim 34, wherein said void is an oval shaped slot in a surface of said bristle cap.

52. A method of grooming for use with a dispensing brush including a handle mounted to a head and a bristle cap with bristles extending from said bristle cap, the bristle cap mounted to said head, a substantially sealable internal cavity including a intake reservoir, a pump mounted to said head including an intake in communication with said intake reservoir of said internal cavity and an output adjacent to said bristle cap; and a void in said bristle cap, thereby enabling passage of a fluid from said pump through said void, the method of grooming including the steps of:
providing a fluid that is placed in said internal cavity;
positioning said bristles adjacent to a receiver; and
actuating said pump and dispensing said fluid through said void onto said receiver.

53. The method of grooming as in claim 52, further including the step of:
brushing said receiver as said fluid is being dispensed.
